(19) United States
(12) Patent Application Publication
(10) Pub. No.: US 2026/0267385 A1
(43) Pub. Date: Sep. 10, 2026

(54) PREDICTIVE FAILURE NOTIFICATION AND TIME RESILIENCY SYSTEM AND METHOD FOR A BMC

(71) Applicant: Dell Products L.P., Round Rock, TX (US)

(72) Inventors: Parminder Singh Sethi, Ludhiana (IN); Mohan Pujari, Belagavi (IN); Naveen Gopala, Bangalore (IN); Vasantha Kumar Venkataramanappa, Bengaluru (IN)

(73) Assignee: Dell Products L.P., Round Rock, TX (US)

(21) Appl. No.: 19/069,312

(22) Filed: Mar. 4, 2025

(51) Int. Cl. G06F 1/28; G06F 1/14

(52) U.S. Cl. CPC G06F 1/28; G06F 1/14

(57) ABSTRACT

Embodiments of the present disclosure provide a predictive failure notification and time resiliency system and method for a Baseboard Management Controller (BMC) that monitors the RTC battery of a IHS to predict future failures, and if such failures do occur, provide an alternative time source until the battery is replaced. According to one embodiment, an Information Handling System (IHS) includes a real time clock, and a BMC. The BMC includes instructions to obtain a current voltage measurement of a battery that powers the RTC, compare the current voltage measurement against a previous voltage measurement of the battery, and when the current voltage measurement is reduced relative to the previous voltage measurement by a specified threshold amount, stop synchronizing a system time of the BMC with the RTC.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware, and software components that may be configured to process, store, and communicate information and may include one or more computer systems, data storage systems, and networking systems.

In modern day IHSs, administrative management is often provided via baseboard management controllers (BMCs). The baseboard management controller (BMC) generally includes a specialized microcontroller embedded on the motherboard of the IHS, and provides an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC to take some corrective actions – such as resetting or power cycling the system to get a hung O/S running again. These abilities save on the total cost of ownership of an IHS.

### SUMMARY

Embodiments of the present disclosure provide a predictive failure notification and time resiliency system and method for a Baseboard Management Controller (BMC) that monitors the RTC battery of an IHS to predict future failures, and if such failures do occur, provide an alternative time source until the battery is replaced. According to one embodiment, an Information Handling System (IHS) includes a real time clock, and a BMC. The BMC includes instructions to obtain a current voltage measurement of a battery that powers the RTC, compare the current voltage measurement against a previous voltage measurement of the battery, and when the current voltage measurement is reduced relative to the previous voltage measurement by a specified threshold amount, stop synchronizing a system time of the BMC with the RTC.

According to another embodiment, a real time clock (RTC) battery monitoring and time resiliency method includes the steps of obtaining a current voltage measurement of a battery that powers a RTC of an Information Handling System (IHS), comparing the current voltage measurement against a previous voltage measurement of the battery, and when the current voltage measurement is reduced relative to the previous voltage measurement by a specified threshold amount, stopping synchronization of a system time of a Baseboard Management Controller (BMC) with the RTC.

According to yet another embodiment, a non-transitory hardware memory device has program instructions stored thereon that, upon execution by a baseboard Management Controller (BMC) of an Information Handling System (IHS), cause the BMC to obtain a current voltage measurement of a battery that powers a real time clock (RTC) of an Information Handling System (IHS), compare the current voltage measurement against a previous voltage measurement of the battery, and when the current voltage measurement is reduced relative to the previous voltage measurement by a specified threshold amount, stop synchronizing a system time of the BMC with the RTC.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a block diagram of examples of components of an Information Handling System (IHS), according to some embodiments.

FIG. 2 illustrates an example RTC battery monitoring and time resiliency system that may be used to monitor a RTC battery and provide time resiliency for a BMC according to one embodiment of the present disclosure.

FIG. 3 is a diagram illustrating how the time guardian daemon may arbitrate for another time setting for the BMC when the RTC time has been reset according to one embodiment of the present disclosure.

FIG. 4 is a diagram illustrating how the battery sensor manager may monitor the coin-cell battery in order to predict its battery failure according to one embodiment of the present disclosure.

FIG. 5 illustrates an example RTC battery monitoring and time resiliency method showing how the RTC battery monitoring and time resiliency system may be used to monitor and remediate problems with a failed coin-cell battery according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer’s operating system or BIOS) hardware management tasks. The BMC firmware can support industry-standard specifications, such as the Intelligent Platform Management Interface (IPMI) and Systems Management Architecture of Server Hardware (SMASH) for computer system administration.

In an On-premises data center environment, such as where Baseboard Management Controller (BMC) is not exposed to external world via the Internet, time management of a BMC often conventionally relies solely on a Real-Time-Clock (RTC) hardware chip configured in the BMC. The RTC chip maintains the system time of the BMC even in the absence of system power, as it is supported by a dedicated coin-cell battery. An RTC failure event caused by a failure of the coin-cell battery often causes the RTC time to become reset (e.g., resets to January 1, 2000). This, in turn, compromises the system time, which relies upon the RTC time, which often leads to cascading catastrophic failures, such as Security Certificate Expiry, Remote Accessibility Failures, software or Firmware Updates, and the like. As will be described in detail herein below, embodiments of the present disclosure provide a predictive failure notification and time resiliency system and method for a BMC that monitors the RTC battery of an IHS to predict future failures, and if such failures do occur, provide an alternative time source until the battery is replaced.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, science, control, or other purposes. For example, an IHS may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

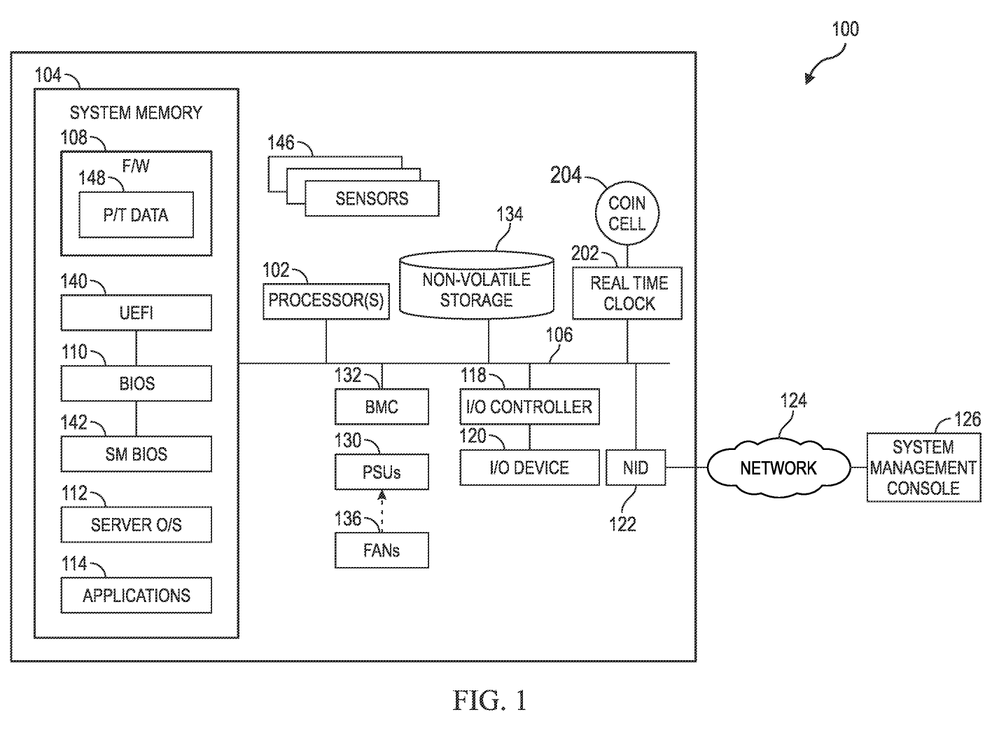

FIG. 1 is a block diagram of examples of components of an Information Handling System (IHS), according to some embodiments. Particularly, IHS 100 includes one or more processor(s) 102 coupled to system memory 104 via system interconnect 106. System interconnect 106 may include any suitable system bus. System memory 104 may include a plurality of software and/or firmware modules including firmware (F/W) 108, basic input/output system (BIOS) 110, operating system (O/S) 112, and/or application(s) 114. Software and/or firmware module(s) stored within system memory 104 may be loaded into processor(s) 102 and executed during operation of IHS 100.

F/W 108 may include a power/thermal profile data table 148 that is used to store power profile data and thermal profile data for certain hardware devices (e.g., processor(s) 102, system memory 104, non-volatile storage 134, NID 122, I/O controllers 118, etc.). System memory 104 may include a UEFI interface 140 and/or a SMBIOS interface 142 for accessing the BIOS as well as updating BIOS 110. In general, UEFI interface 140 provides a software interface between an operating system and BIOS 110. In many cases, UEFI interface 140 can support remote diagnostics and repair of computers, even with no operating system installed. SMBIOS interface 142 can be used to read management information produced by BIOS 110 of a IHS 100. This feature can eliminate the need for the operating system to probe hardware directly to discover what devices are present in the computer. The IHS 100 may also include a real time clock (RTC) 202 powered by a coin cell battery 204.

IHS 100 includes one or more input/output (I/O) controllers 118 which manages the operation of one or more connected input/output (I/O) device(s) 120, such as a keyboard, mouse, touch screen, microphone, a monitor or display device, a camera, a microphone, audio speaker(s) (not shown), an optical reader, a universal serial bus (USB), a card reader, Personal Computer Memory Card International Association (PCMCIA) slot, and/or a high-definition multimedia interface (HDMI), may be included or coupled to IHS 100.

IHS 100 includes Network Interface Device (NID) 122. NID 122 enables IHS 100 to communicate and/or interface with other devices, services, and components that are located externally to IHS 100. These devices, services, and components, such as a system management console 126, can interface with IHS 100 via an external network, such as network 124, which may include a local area network, wide area network, personal area network, the Internet, etc.

IHS 100 further includes one or more power supply units (PSUs) 130. PSUs 130 are coupled to a BMC 132 via an I²C bus. BMC 132 enables remote operation control of PSUs 130 and other components within IHS 100. PSUs 130 power the hardware devices of IHS 100 (e.g., processor(s) 102, system memory 104, non-volatile storage 134, NID 122, I/O controllers 118, PSUs 130, etc.). To assist with maintaining temperatures within specifications, an active cooling system, such as one or more fans 136 may be utilized.

IHS 100 further includes one or more sensors 146. Sensors 146 may, for instance, include a thermal sensor that is in thermal communication with certain hardware devices that generate relatively large amounts of heat, such as processors 102 or PSUs 130. Sensors 146 may also include voltage sensors that communicate signals to BMC 132 associated with, for example, an electrical voltage or current at an input line of PSU 130, and/or an electrical voltage or current at an output line of PSU 130.

BMC 132 may be configured to provide out-of-band management facilities for IHS 100. Management operations may be performed by BMC 132 even if IHS 100 is powered off, or powered down to a standby state. BMC 132 may include a processor, memory, and an out-of-band network interface separate from and physically isolated from an in-band network interface of IHS 100, and/or other embedded resources.

In certain embodiments, BMC 132 may include or may be part of a Remote Access Controller (e.g., a DELL Remote Access Controller (DRAC) or an Integrated DRAC (iDRAC)). In other embodiments, BMC 132 may include or may be an integral part of a Chassis Management Controller (CMC).

In many cases, the hardware devices configured on a typical IHS 100 are registered in its system BIOS. In such cases, BIOS 110 may be accessed to obtain the power/thermal profile data table 148 for those hardware devices registered in BIOS 110. For any non-registered (unsupported/unqualified) hardware device, however, its power profile and/or thermal profile may be unknown. In such situations, the server thermal control is often required to run in an open loop. That is, the thermal profile for the IHS 100 may be difficult, if not impossible, to optimize.

Power related issues also exist. For example, if a non-registered hardware device draws power beyond a maximum capacity of PSU(s) 130 is reached or exceeded, hardware protection may prevent the IHS from even booting. Additionally, if the incoming non-registered hardware device’s power budget is higher than existing power capacity of the system, it can, and often will, halt the IHS during BIOS Power On Self Test (POST), such as with an F1 and/or F2 error.

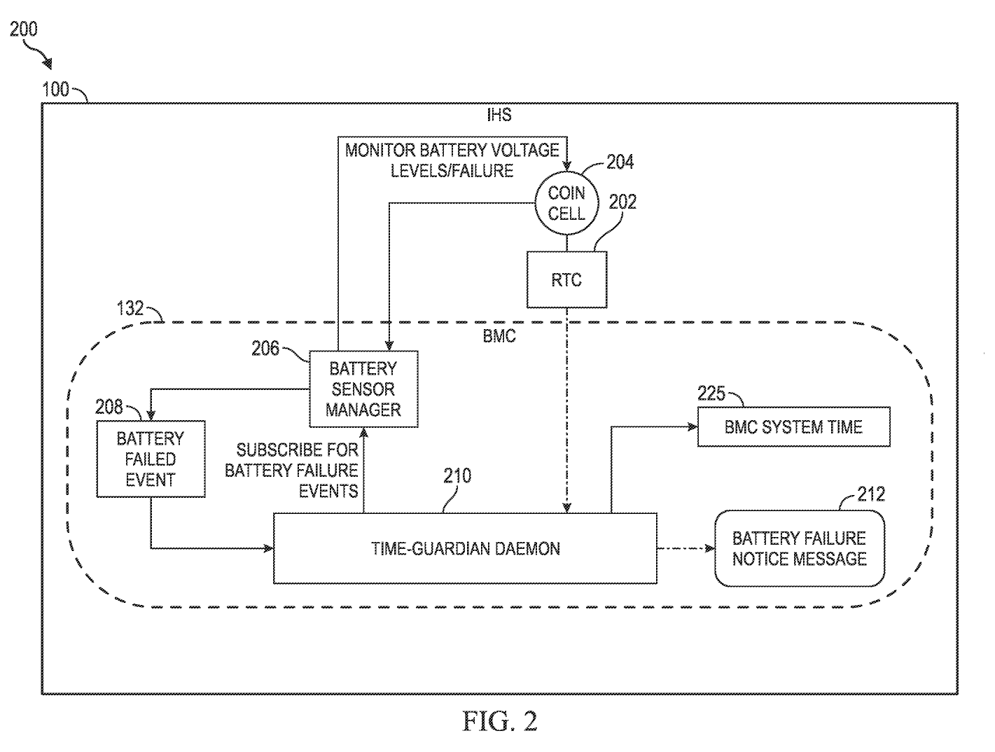

FIG. 2 illustrates an example RTC battery monitoring and time resiliency system 200 that may be used to monitor a RTC battery and provide time resiliency for a BMC 132 according to one embodiment of the present disclosure. The RTC battery monitoring and time resiliency system 200 includes a BMC 132 that is configured with the system time RTC 202, which is powered by a coin-cell battery 204. As mentioned previously, time management of the system time 225 of a BMC 132 is often provided by the RTC 202 configured in the IHS 100, such as in an on-premises data center environment.

According to embodiments of the present disclosure, the RTC battery monitoring and time resiliency system 200 includes a battery sensor manager 206 that continually monitors the voltage level of the coin-cell battery 204 so that, whenever the battery drops below a specified threshold, it generates a battery failure event message 208 that is sent to a time guardian daemon 210. In response to the battery failure event message 208, the time guardian daemon 210 may generate a battery failure notice 212, such as to the system management console 126, to notify personnel that the battery 204 has failed or is predicted to fail in the near future.

Any specified threshold may be used. For example, the coin-cell battery 204 may be considered to be failed when its voltage drops below 10.0 percent (%) of its nominal voltage. In another embodiment, the coin-cell battery 204 may be considered to be failed when its voltage drops below a specified threshold over a specified period of time. For example, the coin-cell battery 204 may be considered to be failed when its voltage drops below 10.0 percent (%) over a half day period.

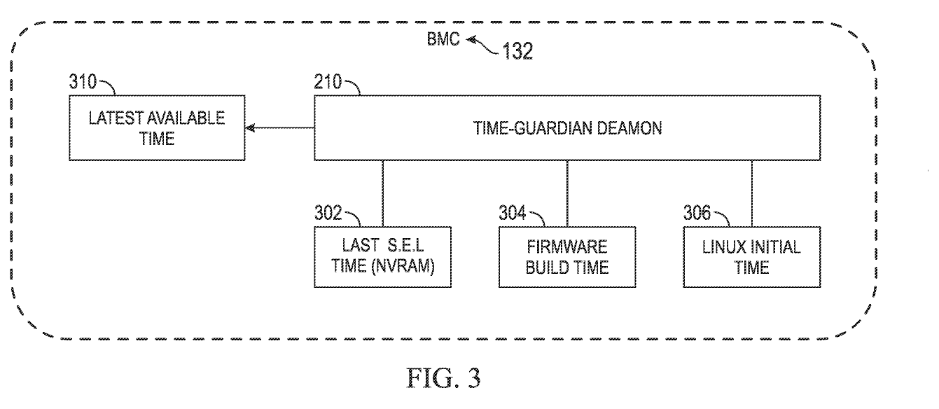

FIG. 3 is a diagram illustrating how the time guardian daemon 210 may arbitrate for another time setting for the BMC 132 when the RTC time has been reset according to one embodiment of the present disclosure. In one embodiment, the time guardian daemon 210 may, in response to receipt of the battery failure event message 208, stop syncing the BMC system time 225 to that of the RTC 202. In another embodiment, the time guardian daemon 210 may, in response to receipt of the battery failure event message 208, check if the time on the RTC 202 has been reset (e.g., January 1, 2000), and if so, arbitrate for another time setting for the BMC 132 from among multiple available time sources in the BMC 132. That is, the time guardian daemon 210 may search through the BMC 132 for an available time source to set the BMC 132 to if and when the time on the RTC 202 has been reset.

In one embodiment, the available time may include the most recent added System Event Log timestamp from non-volatile random access memory (NVRAM) 302, a firmware build time 304 from the file system of the BMC 132, and/or a default BMC Linux boot time 306. Once obtained, the time guardian daemon 210 may select a latest time (e.g., most recent time) setting 310 from each of the available time sources 302, 304, 306, and set the time on the BMC 132 to have that time. Thus, upon the event of failure of the coin-cell battery 204, the time guardian daemon 210 may effectively strengthen a time resiliency of the BMC 132 by calculating the most appropriate available time sources, thereby avoiding catastrophic failures, such as those that may be caused by Security Certificate Expiry, Remote Accessibility Failures, software or Firmware Updates, and the like.

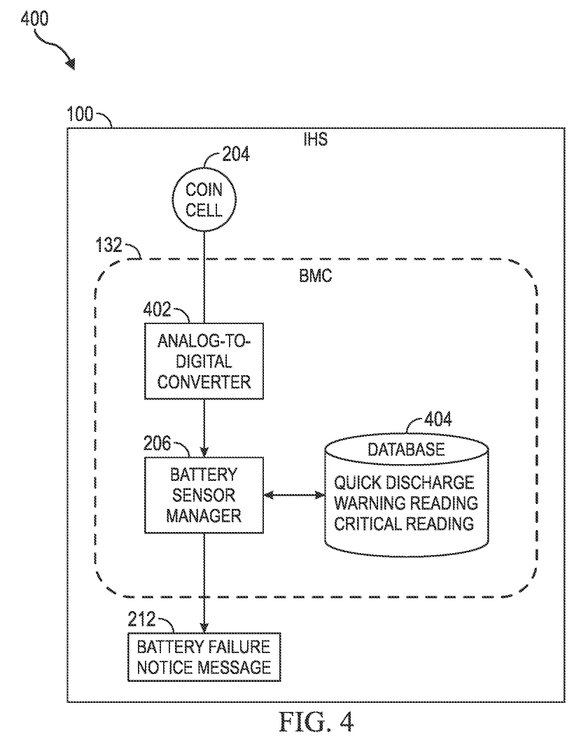

FIG. 4 is a diagram 400 illustrating how the battery sensor manager 206 may monitor the coin-cell battery 204 in order to predict its battery failure according to one embodiment of the present disclosure. The battery sensor manager 206 receives battery voltage measurements from an analog-to-digital (ATD) converter 402 at ongoing intervals (e.g., periodically), and compares the most recent voltage measurement with historical measurements stored in a database 404. In this manner, the battery sensor manager 206 can estimate or predict that the coin-cell battery 204 is likely to fail in the near future and send a battery failure notice 212 to alert the user that a failure of the RTC 202 is likely to fail in the near future. For example, the battery sensor manager 206 may determine that, after 8 hours have transpired, the voltage of the coin-cell battery 204 has dropped to a threshold of 5% of its nominal voltage level and issues a warning battery failure notice 212 to the user. Furthering this example, the battery sensor manager 206 may determine that, after 8 hours have transpired, the voltage of the coin-cell battery 204 has dropped to a threshold of 10% of its nominal voltage level and issues a quick discharge warning battery failure notice 212 to the user. Yet further, the battery sensor manager 206 may determine that, after 8 hours have transpired, the voltage of the coin-cell battery 204 has dropped to a threshold of 15% of its nominal voltage level and issues a quick discharge battery failure notice 212 to the user.

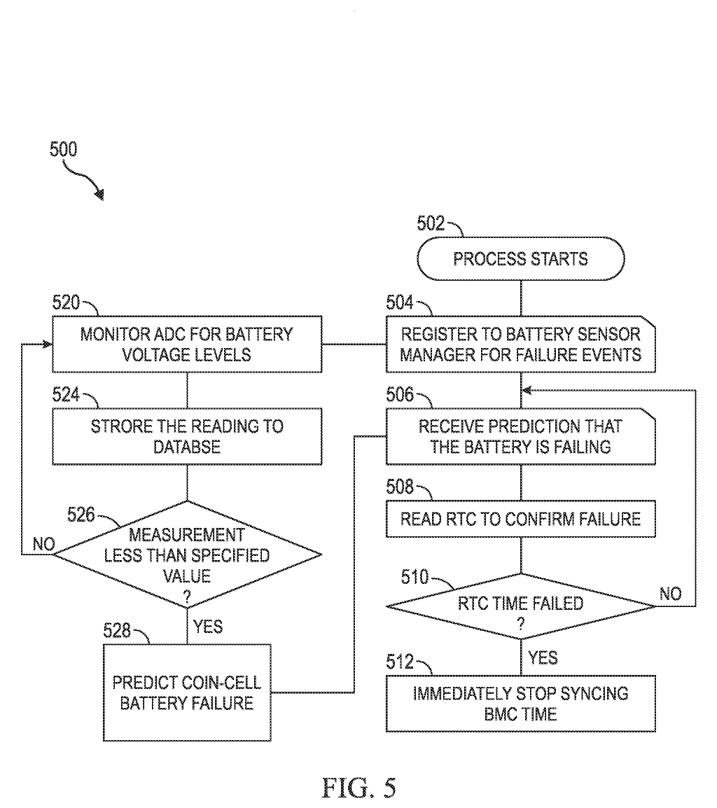

FIG. 5 illustrates an example RTC battery monitoring and time resiliency method 500 showing how the RTC battery monitoring and time resiliency system 200 may be used to monitor and remediate problems with a failed coin-cell battery 204 according to one embodiment of the present disclosure. Additionally or alternatively, the RTC battery monitoring and time resiliency method 500 may be performed by the RTC battery monitoring and time resiliency system 200 as described above with reference to FIG. 2. The steps of the RTC battery monitoring and time resiliency method 500 may be performed by any suitable entity or group of entities. In one embodiment, steps 520-528 may be performed by the battery sensor manager 206, while steps 504-512 are performed by the time guardian daemon 210.

At step 502, the RTC battery monitoring and time resiliency method 500 starts. At step 504, the time guardian daemon 210 registers to the battery sensor manager 206 for receiving coin-cell battery 204 voltage measurements. At step 520, the battery sensor manager 206 obtains voltage measurements at ongoing intervals (e.g., periodically), and at step 524, stores the obtained voltage measurements. Thereafter at step 526, the battery sensor manager 206 determines whether the measured voltage is less than a specified value. If not, the battery sensor manager 206 continues processing at step 520 to obtain ongoing measurements; otherwise, processing continues at step 528 to predict that a coin-cell battery failure has occurred. For example, the battery sensor manager 206 may compare the most recent voltage measurement against a previous voltage measurement (e.g., a measurement from 1 hour ago, 8 hours ago, 12 hours ago, etc.) to determine that the voltage is decreasing to predict that the coin-cell battery 204 is failing.

Thereafter at step 506, the time guardian daemon 210 receives an indication from the battery sensor manager 206 that the coin-cell battery 204 is failing, and at step 508 reads the RTC 202 to confirm failure of the RTC 202. At step 510, the time guardian daemon 210 determines whether the RTC 202 has failed. For example, the time guardian daemon 210 may determine whether the RTC 202 has been reset to a default value (e.g., January 1, 2000). If not, processing continues at step 506; otherwise, processing continues at step 512 in which the system time 225 of the BMC 132 stops being synchronized with the RTC 202. Additionally, the time guardian daemon 210 may obtain time values from one or more available time sources, and select to time to set the BMC 132 to. In one embodiment, the time guardian daemon 210 may compare the time values of multiple available time sources and set the BMC 132 to the latest time value. In this manner, the BMC 132 would have the least likelihood of triggering any time-based failures of the BMC 132, such as Security Certificate Expiration, Remote Accessibility Failures, software or Firmware Updates, and the like. Additional details

Although FIG. 5 describes one example of a method that may be performed to predict a coin-cell battery 204, and enhancing the resiliency of the BMC 132 from cascading failures that may occur due to a failed RTC 202, the features of the disclosed process may be embodied in other specific forms without deviating from the spirit and scope of the present disclosure. For example, RTC battery monitoring and time resiliency method 500 may perform additional, fewer, or different operations than those operations as described in the present example. As another example, the steps of the process described herein may be performed by a components other than the battery sensor manager 206 and/or time guardian daemon 210, such as by processor(s) 102 configured on the IHS 100.

It should be understood that various operations described herein may be implemented in software or software modules executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements that such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a real time clock (RTC); and
a Baseboard Management Controller (BMC) in communication with the real time clock, the BMC including:
a baseboard processor; and
baseboard memory including instructions that, upon execution by the baseboard processor, cause the BMC to:
obtain a current voltage measurement of a battery that powers the RTC;
compare the current voltage measurement against a previous voltage measurement of the battery; and
when the current voltage measurement is reduced relative to the previous voltage measurement by a specified threshold amount, stop synchronizing a system time of the BMC with the RTC.

2. The IHS of claim 1, wherein the instructions further cause the BMC to, when the current voltage measurement is reduced relative to the previous voltage measurement by the specified threshold amount, send a battery failure notice to a user of the IHS.

3. The IHS of claim 1, wherein the instructions further cause the BMC to, when the current voltage measurement is reduced relative to the previous voltage measurement by the specified threshold amount, obtain a time value from an available time source, and set the BMC to the obtained time value.

4. The IHS of claim 3, wherein the instructions further cause the BMC to, when the current voltage measurement is reduced relative to the previous voltage measurement by the specified threshold amount, obtain a plurality of time values from a plurality of available time sources, select one of the time values that is the most current, and set the BMC to the one time value.

5. The IHS of claim 4, wherein the available time sources comprises at least one of a most recent added System Event Log timestamp from non-volatile random access memory (NVRAM), a firmware build time from the file system of the BMC, and a default BMC boot time.

6. The IHS of claim 1, wherein the instructions further cause the BMC to, when the current voltage measurement is reduced relative to the previous voltage measurement within a specified time period, stop synchronizing the system time of the BMC with the RTC.

7. The IHS of claim 1, wherein the RTC is configured on the IHS.

8. The IHS of claim 1, wherein the instructions further cause the BMC to obtain the current voltage measurement and previous voltage measurement using an analog-to-digital (ADC) converter.

9. A real time clock (RTC) battery monitoring and time resiliency method, comprising:
obtaining a current voltage measurement of a battery that powers a RTC of an Information Handling System (IHS);
comparing the current voltage measurement against a previous voltage measurement of the battery; and
when the current voltage measurement is reduced relative to the previous voltage measurement by a specified threshold amount, stopping synchronization of a system time of a Baseboard Management Controller (BMC) with the RTC.

10. The RTC battery monitoring and time resiliency method of claim 9, further comprising, when the current voltage measurement is reduced relative to the previous voltage measurement by the specified threshold amount, sending a battery failure notice to a user of the IHS.

11. The RTC battery monitoring and time resiliency method of claim 9, further comprising, when the current voltage measurement is reduced relative to the previous voltage measurement by the specified threshold amount, obtaining a time value from an available time source, and set the BMC to the obtained time value.

12. The RTC battery monitoring and time resiliency method of claim 11, further comprising when the current voltage measurement is reduced relative to the previous voltage measurement by the specified threshold amount, obtaining a plurality of time values from a plurality of available time sources, select one of the time values that is the most current, and set the BMC to the one time value.

13. The RTC battery monitoring and time resiliency method of claim 9, further comprising, when the current voltage measurement is reduced relative to the previous voltage measurement withing a specified time period, stop synchronizing the system time of the BMC with the RTC.

14. The RTC battery monitoring and time resiliency method of claim 9, further comprising obtaining the current voltage measurement and previous voltage measurement using an analog-to-digital (ADC) converter.

15. A non-transitory hardware memory device having program instructions stored thereon that, upon execution by a baseboard Management Controller (BMC) of an Information Handling System (IHS), cause the BMC to:
obtain a current voltage measurement of a battery that powers a real time clock (RTC) of an Information Handling System (IHS);
compare the current voltage measurement against a previous voltage measurement of the battery; and
when the current voltage measurement is reduced relative to the previous voltage measurement by a specified threshold amount, stop synchronizing a system time of the BMC with the RTC.

16. The non-transitory hardware memory device of claim 1, wherein the instructions further cause the BMC to, when the current voltage measurement is reduced relative to the previous voltage measurement by the specified threshold amount, send a battery failure notice to a user of the IHS.

17. The non-transitory hardware memory device of claim 15, wherein the instructions further cause the BMC to, when the current voltage measurement is reduced relative to the previous voltage measurement by the specified threshold amount, obtain a time value from an available time source, and set the BMC to the obtained time value.

18. The non-transitory hardware memory device of claim 17, wherein the instructions further cause the BMC to, when the current voltage measurement is reduced relative to the previous voltage measurement by the specified threshold amount, obtain a plurality of time values from a plurality of available time sources, select one of the time values that is the most current, and set the BMC to the one time value.

19. The non-transitory hardware memory device of claim 18, wherein the available time sources comprises at least one of a most recent added System Event Log timestamp from non-volatile random access memory (NVRAM), a firmware build time from the file system of the BMC, and a default BMC boot time.

20. The non-transitory hardware memory device of claim 15, wherein the instructions further cause the BMC to, when the current voltage measurement is reduced relative to the previous voltage measurement within a specified time period, stop synchronizing the system time of the BMC with the RTC.
